(19) United States
(12) Patent Application Publication
(10) Pub. No.: US 2025/0072505 A1
(43) Pub. Date: Mar. 6, 2025

(54) HEATING ASSEMBLY AND AEROSOL GENERATING DEVICE INCLUDING THE SAME

(71) Applicant: KT&G CORPORATION, Daejeon (KR)

(72) Inventors: Chul Ho JANG, Gyeonggi-do (KR); Gyoung Min GO, Daejeon (KR); Jang Won SEO, Daejeon (KR); Jin Chul JUNG, Daejeon (KR)

(73) Assignee: KT&G CORPORATION, Daejeon (KR)

(21) Appl. No.: 18/562,967

(22) PCT Filed: Aug. 29, 2023
(86) PCT No.: PCT/KR2023/012775

§ 371 Date: Nov. 21, 2023

(30) Foreign Application Priority Data
Sep. 28, 2022 (KR) 10-2022-0123473

(51) Int. Cl. A24F 40/465; A24F 40/20; A24F 40/485; A24F 40/51; A24F 40/57; A24F 40/60; A24F 40/65

(52) U.S. Cl. CPC A24F 40/465; A24F 40/20; A24F 40/485; A24F 40/51; A24F 40/57; A24F 40/60; A24F 40/65

(57) ABSTRACT

The present disclosure relates to a heating assembly including an accommodating unit configured to accommodate an aerosol generating article heatable by an induced magnetic field, a spiral coil arranged outside the accommodating unit and configured to generate an induced magnetic field toward the accommodating unit, and a first supporter arranged at a side in the accommodating unit, supporting an outer surface of the aerosol generating article, and separating the outer surface of the aerosol generating article accommodated in the accommodating unit from an inner wall of the accommodating unit, wherein the spiral coil is wound to form a plate shape covering a portion of an outer wall of the accommodating unit, and a center around which the spiral coil is wound is arranged at a point of the outer wall of the accommodating unit.

### TECHNICAL FIELD

Embodiments relate to a heating assembly and an aerosol generating device including the same, and more particularly, to a heating assembly capable of effectively heating a susceptor included in an aerosol generating article, and an aerosol generating device including the heating assembly.

### BACKGROUND ART

Recently, the demand for alternative methods for overcoming the disadvantages of traditional cigarettes has increased. For example, there is growing demand for an aerosol generating device that generates an aerosol by heating or atomizing an aerosol generating material in a cigarette or a cartridge, instead of burning a cigarette.

Recently, an aerosol generating apparatus that may generate an aerosol by heating an aerosol generating article has been suggested as a way to replace a method of supplying an aerosol by burning cigarettes. The aerosol generating apparatus may be, for example, an apparatus capable of generating an aerosol by heating an aerosol generating material in a liquid or solid state through a heater to a predetermined temperature.

When an aerosol generating apparatus is used, smoking can be performed without additional supplies such as a lighter, and a user's smoking convenience can be enhanced as a user can smoke as much as he/she wants. Thus, research on aerosol generating apparatuses has gradually increased.

### DISCLOSURE OF INVENTION

### Technical Problem

Conventional induction-heating type aerosol generating devices include a susceptor and a coil, and the susceptor may be heated by a magnetic field generated by the coil to transfer heat energy to an aerosol generating article.

In recent years, a method of heating susceptors consisting of aluminum materials included in aerosol generating articles without arranging a separate susceptor in the aerosol generating device has been actively studied. However, since the shape of coils used in conventional induction-heating type aerosol generating devices are not suitable for heating aluminum materials included in aerosol generating articles, there is a need for a coil having a new shape to efficiently heat the aerosol generating article.

Embodiments provide a heating assembly including a coil having a shape that may efficiently heat a susceptor included in an aerosol generating device and an aerosol generating device including the heating assembly.

In addition, embodiments provide a heating assembly in which components are apart from each other to form a space where airflow may move inside the heating assembly, and an aerosol generating device including the heating assembly.

Objects to be achieved by the embodiments are not limited to the above-described objects, and objects not described may be clearly understood by those skilled in the art to which the embodiments belong from the present specification and the accompanying drawings.

### Solution to Problem

Embodiments provide a heating assembly and an aerosol generating device including the heating assembly.

According to an embodiment, a heating assembly includes an accommodating unit accommodating an aerosol generating article heatable by an induced magnetic field, a spiral coil arranged outside the accommodating unit and generating an induced magnetic field toward the accommodating unit, and a first supporter arranged at a side in the accommodating unit, supporting an outer surface of the aerosol generating article, and separating the outer surface of the aerosol generating article accommodated in the accommodating unit from an inner wall of the accommodating unit, wherein the spiral coil is wound to form a plate shape covering a portion of an outer wall of the accommodating unit, and a center around which the spiral coil is wound is arranged at a point of the outer wall of the accommodating unit.

According to an embodiment, an aerosol generating device may include the above-described heating assembly, a housing accommodating the heating assembly, and a battery supplying power to the heating assembly.

### Advantageous Effects of Invention

According to embodiments, a heating assembly and an aerosol generating device including the same may effectively heat a susceptor included in an aerosol generating article.

In addition, in the heating assembly and the aerosol generating device including the same according to embodiments, airflow may be smoothly moved inside the heating assembly.

The effects according to one or more embodiments are not limited to the effects described above, and unmentioned effects will be clearly understood by one of ordinary skill in the art from the present specification and the accompanying drawings.

### BRIEF DESCRIPTION OF DRAWINGS

FIG. 1 is a perspective view schematically showing an aerosol generating device into which an aerosol generating article is inserted, according to an embodiment;

FIG. 2 is an exploded perspective view of an aerosol generating device according to an embodiment;

FIG. 3 is a view schematically illustrating a spiral coil of an aerosol generating device according to an embodiment;

FIG. 4 is a view for explaining a direction of a magnetic force line generated by a spiral coil of an aerosol generating device, according to an embodiment;

FIG. 5 is a cross-sectional view of the aerosol generating device illustrated in FIG. 1, taken along a line A-A;

FIG. 6 is a perspective view of a heating assembly into which an aerosol generating article is inserted, according to an embodiment;

FIG. 7 is a cross-sectional view of the heating assembly illustrated in FIG. 6, taken along a line B-B;

FIG. 8 is a perspective view of a portion of an accommodating unit, the view being a cross-section in a direction crossing the length direction of the accommodating unit of FIG. 6;

FIG. 9 is a plan view of an aerosol generating article accommodated in a portion of the accommodating unit shown in FIG. 8;

FIG. 10 is a perspective view of the other portion of the accommodating unit shown in FIG. 6;

FIG. 11 is a cross-sectional view of the heating assembly shown in FIG. 6, taken along a C-C direction;

FIG. 12 is a cross-sectional view of a portion of the heating assembly shown in FIG. 5;

FIG. 13 illustrates an example of an aerosol generating article;

FIG. 14 is a view schematically illustrating a coil of a conventional aerosol generating device;

FIG. 15 is a view for explaining a direction of a magnetic force line generated by a coil of a conventional aerosol generating device;

FIG. 16 is a graph showing a result of an experiment conducted to compare the heating performance of the aerosol generating device according to an embodiment and the conventional aerosol generating device; and

FIG. 17 is a block diagram of an aerosol generating device according to another embodiment.

### MODE FOR THE INVENTION

With respect to the terms used to describe in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, expressions such as “at least one of,” when preceding a list of elements, modify the entire list of elements and do not modify the individual elements of the list. For example, the expression, “at least one of a, b, and c.” should be understood as including only a, only b, only c, both a and b, both a and c, both b and c, or all of a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. In addition, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge containing an aerosol generating material and a main body supporting the cartridge. The cartridge may be coupled to the main body to be detachable, but embodiments are not limited thereto. The cartridge may be integrated with or assembled to the main body, and may be fixed so as not to be detached by a user. The cartridge may be coupled to the main body while accommodating aerosol generating material therein. But embodiments are not limited thereto, and the aerosol generating material may be inserted into the cartridge at a state where the cartridge is coupled to the main body.

The cartridge may contain an aerosol generating material in any one of various states such as a liquid state, a solid state, a gaseous state, or a gel state. The aerosol generating material may include a liquid composition. For example, the liquid composition may be a liquid including a tobacco-containing material having a volatile tobacco flavor component, or a liquid including a non-tobacco material.

The cartridge is operated by an electrical signal or a wireless signal transmitted from the main body to perform a function of generating aerosol by converting the phase of the aerosol generating material inside the cartridge to a gaseous phase. The aerosol may denote a gas in a state in which vaporized particles generated from the aerosol generating material and air are mixed.

In another embodiment, the aerosol generating device may generate aerosols by heating a liquid composition, and generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. In this case, the ultrasonic vibration method may refer to a method of generating an aerosol by atomizing an aerosol generating material by using ultrasonic vibration generated by a vibrator.

The aerosol generating device may include a vibrator, and the vibrator may generate a short period of vibration to atomize the aerosol generating material. The vibration generated by the vibrator may be an ultrasound vibration, and the frequency band of the ultrasound vibration may be about 100 kHz to about 3.5 MHZ, but is not limited thereto.

The aerosol generating device may further include a wick that absorbs the aerosol generating material. For example, the wick may be arranged to wrap at least one area of the vibrator or to be in contact with at least one area of the vibrator.

As the voltage (e.g., AC voltage) is applied to the vibrator, heat and/or ultrasonic vibration may be generated from the vibrator, and the heat and/or ultrasonic vibration generated from the vibrator may be transmitted to the aerosol generating material absorbed into the wick. The aerosol generating material absorbed into the wick may be converted to a gas phase by heat and/or ultrasonic vibration transmitted from the vibrator, and as a result, aerosol may be generated.

For example, the viscosity of the aerosol generating material absorbed into the wick by the heat generated from the vibrator may be lowered, and the aerosol generating material of which the viscosity is lowered by the ultrasonic vibration generated from the vibrator may be divided into fine particles, thereby generating aerosol, but embodiments are not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the susceptor may be a magnetic body that generates heat by an external magnetic field. As the susceptor is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may constitute a system with a separate cradle. For example, the cradle may be used to charge the battery of the aerosol generating device. Alternatively, the heater may be heated when the cradle is coupled to the aerosol generating device.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in the aerosol generating devices of various embodiments described above, or may be implemented in various different forms, and is not limited to the embodiments described herein.

Hereinafter, embodiments of the present disclosure will be described in detail with reference to the drawings.

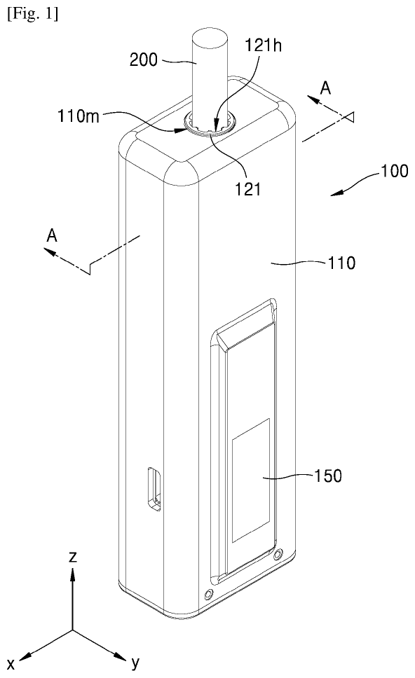

FIG. 1 is a perspective view schematically showing an aerosol generating device into which an aerosol generating article is inserted, according to an embodiment.

Referring to FIG. 1, an aerosol generating device 100 according to an embodiment may include a housing 110 and a display 150.

The housing 110 may form the overall appearance of the aerosol generating device 100, and may include an inner space (or an arrangement space) in which components of the aerosol generating device 100 may be arranged. Although in the drawings, the housing 110 has a rectangular pillar shape, the shape of the housing 110 is not limited thereto. For example, as a whole, the housing 110 may be formed as a cylindrical shape or as a polygonal column (e.g., a triangular pillar) shape.

In the inner space of the housing 110, components for heating an aerosol generating article 200 inserted into the housing 110 to generate an aerosol may be arranged, but embodiments are not limited thereto. The housing 110 may protect the components.

In an embodiment, the housing 110 may include a mounting hole 110m on which a portion of the accommodating unit 121 for accommodating the aerosol generating article 200 may be mounted. The accommodating unit 121 may be supported by the mounting hole 110m of the housing 110.

The accommodating unit 121 arranged in the inner space of the housing 110 may include an opening 121h through which an aerosol generating article may be inserted into the accommodating unit 121. At least a portion of the aerosol generating article 200 may be inserted or accommodated in the accommodating unit 121 through the opening 121h.

The aerosol generating article 200 inserted or accommodated in the accommodating unit 121 may be heated inside the accommodating unit 121, and as a result, an aerosol may be generated. The user may inhale aerosol discharged from the aerosol generating article 200.

The display 150 may display visual information and at least a portion of the display 150 may be exposed to the outside of the housing 110. The aerosol generating device 100 may provide various visual information to the user through the display 150.

For example, the aerosol generating device 100 may provide information on whether the user's puffing action has occurred and/or information on the number of remaining puffs of the inserted aerosol generating article 200 through the display 150, but the information provided through the display 150 may be modified in various ways.

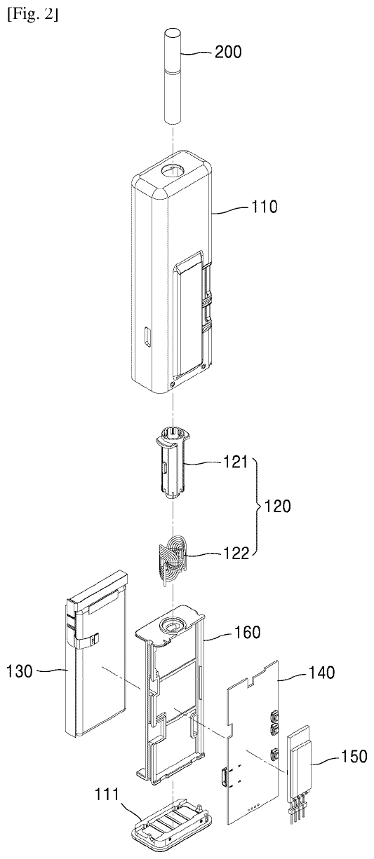

FIG. 2 is an exploded perspective view of an aerosol generating device according to an embodiment.

Referring to FIG. 2, an aerosol generating device 100 according to an embodiment may include a housing 110, a heating assembly 120, a battery 130, a printed circuit board 140, a display 150, and a frame 160.

The aerosol generating device 100 according to an embodiment may generate aerosol by heating the aerosol generating article 200 by an induction heating method. The induction heating method may be a method by which heat is generated from a magnetic body by applying an alternating magnetic field. In this case, the alternating magnetic field may be referred to as an ‘induced magnetic field’.

When an alternating magnetic field is applied to the magnetic body, energy may be lost in the magnetic body because of eddy current loss and hysteresis loss. The lost energy may be emitted from the magnetic body as heat energy. As the amplitude or frequency of the alternating magnetic field increases, greater thermal energy may be emitted from the magnetic body.

At least one of the components of the aerosol generating device 100 according to an embodiment may be the same or substantially the same as at least one of the components of the aerosol generating device 100 illustrated in FIG. 1, and hereinafter, the same descriptions are not repeated.

The housing 110 may accommodate a heating assembly 120, a battery 130, a printed circuit board 140, a display 150, and a frame 160.

To prevent the components accommodated in the housing 110 from coming out of the housing 110, the housing 110 may include a base unit 111.

The base unit 111 is arranged at an end opposite to an end of the housing 110 where the opening (e.g., the opening 121h of FIG. 1) is arranged. The base unit 111 may block an accommodating space of the housing 110 and may support the components arranged in the inner space of the housing 110. For example, the base unit 111 may be in contact with the frame 160 to support the frame 160.

The heating assembly 120 may include the accommodating unit 121 and a spiral coil 122.

At least a portion of the aerosol generating article 200 may be accommodated in the accommodating unit 121. The accommodating unit 121 may include an opening (not shown) for accommodating the aerosol generating article 200 into the aerosol generating device 100. The opening of the accommodating unit 121 may be open towards the outside of the aerosol generating device 100. The aerosol generating article 200 may be accommodated in the heating assembly 120 in a direction from the outside of the accommodating unit 121 to the inside of the accommodating unit 121 through the opening of the accommodating unit 121.

The heating assembly 120 may heat the aerosol generating article 200 accommodated in the accommodating unit 121. In detail, the spiral coil 122 of the heating assembly 120 may be arranged outside the accommodating unit 121 and generate an induced magnetic field toward the accommodating unit 121.

The aerosol generating article 200 accommodated in the accommodating unit 121 includes a susceptor. Through induction heating of the susceptor by an induced magnetic field, the aerosol generating article 200 may be heated.

The spiral coil 122 may be arranged on the outside of the accommodating unit 121 to generate an induced magnetic field. The spiral coil 122 may receive power from the battery 130. As power is supplied to the spiral coil 122, a magnetic field towards the inside of the accommodating unit 121 may be formed.

When an alternating current is applied to the spiral coil 122, a direction of the magnetic field formed inside the accommodating unit 121 may be periodically changed. When the susceptor is exposed to the magnetic field formed by the spiral coil 122, the susceptor may generate heat.

As the amplitude or frequency of the magnetic field formed by the spiral coil 122 changes, the temperature of the susceptor being heated may change. The controller (not shown) may control the power supplied to the spiral coil 122 to adjust the amplitude or the frequency of the alternating magnetic field formed by the spiral coil 122, and thus, the temperature of the susceptor may be controlled.

For example, the spiral coil 122 may include copper, but is not limited thereto. The spiral coil 122 may include an alloy including any one or at least one of silver (Ag), gold (Au), aluminum (Al), tungsten (W), zinc (Zn), and nickel (Ni) so that a high current may flow in the spiral coil 122 with a low resistivity.

The battery 130 supplies power used by the aerosol generating device 100 to operate. For example, the battery 130 may supply power such that an alternating current may be applied to the heating assembly 120, and may supply power for operating the controller. Also, the battery 130 may supply power for operations of the display 150, a sensor (not shown), a motor (not shown), etc. mounted in the aerosol generating device 100.

The printed circuit board PCB 140 may include a controller. The controller may generally control operations of the aerosol generating device 100. In detail, the controller may control not only operations of the battery 130 and the heating assembly 120, but also operations of other components included in the aerosol generating device 100.

Also, the controller may check a state of each of the components of the aerosol generating device 100 to determine whether or not the aerosol generating device 100 is operable.

The controller may include at least one processor. A processor may be implemented as an array of a plurality of logic gates or may be implemented as a combination of a general-purpose microprocessor and a memory in which a program executable in the microprocessor is stored. It will be understood by one of ordinary skill in the art that the processor may be implemented in other forms of hardware.

The frame 160 may support the components arranged in the inner space of the housing 110. For example, the frame 160 may be in contact with at least one surface of the battery 130 and the printed circuit board 140 to support the battery 130 and the printed circuit board 140. In addition, the frame 160 includes a groove (not shown) at one end. At least a portion of the accommodating unit 121 is inserted into the groove such that the frame 160 may support the accommodating unit 121.

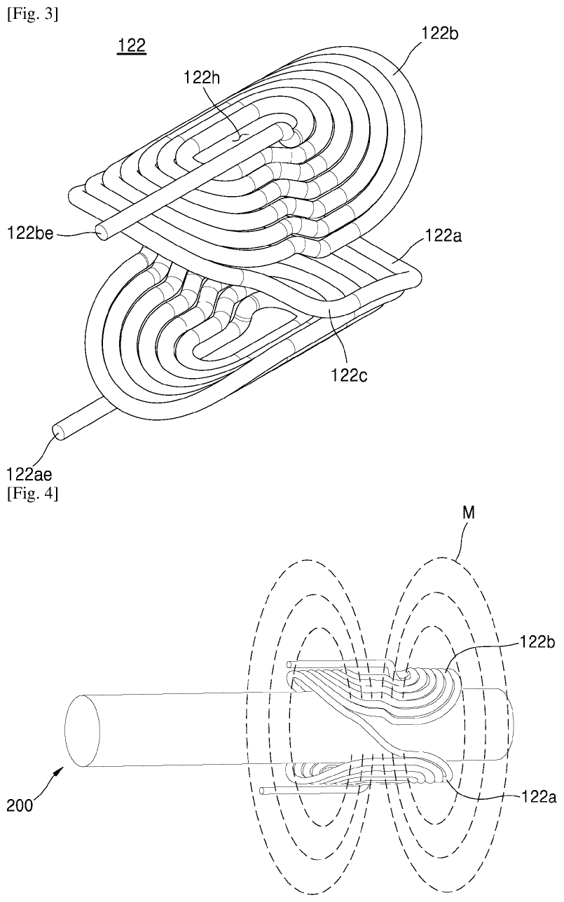

FIGS. 3 and 4 illustrates the spiral coil of the aerosol generating device, according to an embodiment.

FIG. 3 is a view schematically illustrating the spiral coil of the aerosol generating device according to an embodiment, and FIG. 4 is a view illustrating a direction of a line of magnetic force generated by the spiral coil of the aerosol generating device, according to an embodiment.

Referring to FIGS. 3 and 4, the spiral coil 122 may be winded to form a plate shape covering a portion of the outer wall of the accommodating unit 121. A center around which the spiral coil 122 is wound may be arranged in a point of the outer wall of the accommodating unit 121 (the accommodating unit 121 that is not shown in FIGS. 3 and 4 may be referred to in FIG. 2).

‘The spiral coil 122 covering a portion of the outer wall of the accommodating unit 121’ refers to the spiral coil 122 being arranged such that the surface of the inside of the spiral coil 122 (hereinafter referred to as ‘the inner surface of the spiral coil’) is arranged toward the outer wall of the accommodating unit 121. Therefore, ‘the spiral coil 122 covering a portion of the outer wall of the accommodating unit 121’ includes a structure in which the spiral coil 122 is in contact with the outer wall of the accommodating unit 121 and a structure in which the spiral coil 122 is apart from the outer wall of the accommodating unit 121.

‘The outer wall of the accommodating unit 121’ refers to an outer wall of the accommodating unit 121 facing a direction away from the center of the accommodating unit 121 in a radial direction of the accommodating unit 121, and the ‘inner wall of the accommodating unit 121’ refers to an inner wall of the accommodating unit 121 facing the aerosol generating article 200 accommodated in the accommodating unit 121 in a radial direction of the accommodating unit 121. The expression may be used in the same meaning below.

The spiral coil 122 spiral axis may be in a direction crossing the length direction of the accommodating unit 121. In this case, the ‘length direction’ refers to a z-axis direction shown in FIG. 1, and may refer to a direction extending in a direction of the accommodating unit 121. In addition, the ‘length direction’ may refer to a direction in which the aerosol generating article 200 is inserted into the accommodating unit 121. The ‘length direction’ may be used in the same meaning below.

When the outer wall of the accommodating unit 121 includes a curved wall, the spiral coil 122 may have a plate shape curved along the outer wall of the accommodating unit 121. That is, the cross section of the spiral coil 122 in a direction crossing the length direction of the accommodating unit 121 may have an arc shape.

The spiral coil 122 may have a circle shape with respect to the center of the spiral coil 122 around which the spiral coil 122 is wound. However, embodiments are not limited thereto, and the shape of the spiral coil 122 may be modified as needed. For example, the spiral coil may have a square shape based on the center around which the spiral coil is wound.

The spiral coil 122 may include an insertion hole 122h at the center around which the spiral coil 122 is wound. The spiral coil 122 may be coupled to the accommodating unit 121 through the insertion hole 122h and may be supported by the accommodating unit 121.

The spiral coil 122 may form a magnetic field in which a magnetic force line M enters and exits around the spiral axis of the spiral coil 122, according to the direction of the current. That is, the magnetic force line M may enter and exit the accommodating unit 121 in a direction crossing the length direction of the accommodating unit 121, and the magnetic force line M may pass the inside of the aerosol generating article 200 in the direction crossing the length direction of the aerosol generating article 200.

Unlike the coils included in the conventional induction-heating type aerosol generating device, because the direction of the magnetic force line M is a direction crossing the length direction of the aerosol generating device 200, the density of the magnetic force line M passing through the susceptor included in the aerosol generating article 200 may be increased, thereby improving the heating efficiency of the susceptor.

In particular, when the susceptor included in the aerosol generating article 200 extends in an arc direction from inside the aerosol generating article 200 or has a shape of a flat sheet, the magnetic force line M may be heated to a sufficient temperature because the magnetic force line M passes through a large area of the sheet.

A plurality of spiral coils 122 may be arranged. At least a pair of the plurality of spiral coils 122 may be electrically connected to each other. An even number of the spiral coils 122 may be arranged for all of the plurality of spiral coils 122 to form pairs.

As shown in FIGS. 3 and 4, two spiral coils 122 form a pair and are electrically connected to each other. The spiral coils 122 include a first spiral coil 122a and a second spiral coil 122b.

The first spiral coil 122a and the second spiral coil 122b may be electrically connected to each other by a spiral connection portion 122c. The spiral connection portion 122c may connect an edge of the first spiral coil 122a and an edge of the second spiral coil 122b. The electrically connected pair of spiral coils 122 may be made of one conductive line.

Both ends of the conductive line forming a pair of spiral coils 122 may extend in a length direction along the outer wall of the accommodating unit 121 from the center around which the spiral coil 122 is wound to be connected to the battery (e.g., the battery 130 of FIG. 2).

For example, an end of the first spiral coil 122a and an end of the second spiral coil 122b may be electrically connected to each other by the spiral connection portion 122c to form a pair of spiral coils 122 consisting of one conductive line. The other end 122ac of the first spiral coil 122a and the other end 122be of the second spiral coil 122b may each be an end and the other end of the spiral coil 122 and connected to the battery.

The first spiral coil 122a and the second spiral coil 122b may have the same size and shape, and may be arranged symmetrically with respect to the central axis of the accommodating unit 121. However, embodiments are not limited thereto, and the number, sizes, and shapes of spiral coils 122 may change according to necessity.

For example, according to an example in which four spiral coils 122 are arranged outside the accommodating unit 121, the four spiral coils 122 may be apart from each other in the same distance along the outer wall of the accommodating unit 121 in a circumferential direction of the accommodating unit 121.

According to another example in which four spiral coils 122 are arranged outside the accommodating unit 121, a pair of spiral coils may be arranged along the outer wall of the accommodating unit in the circumferential direction of the accommodating unit 121, and the other pair of spiral coils may be arranged apart from the pair of spiral coils in the length direction of the accommodating unit 121. In this case, the other pair of spiral coils may be arranged between the pair of spiral coils in the circumferential direction of the accommodating unit 121.

When a plurality of spiral coils 122 are arranged in pairs electrically connected to each other, thorough controlling of the direction of the alternating current applied to each of the spiral coils 122 is necessary for the intensity of the magnetic field to not be offset by the direction of the magnetic field generated by the plurality of spiral coils 122 to cross each other.

In an embodiment, because a winding direction of each of the plurality of spiral coils 122 is set such that the plurality of spiral coils 122 are electrically connected to each other and that the alternating currents in the spiral coil 122 flow in the same direction, controlling of each of the plurality of spiral coils 122 is not necessary.

Also, as described above, the magnetic force line M may enter in a direction crossing the length direction of the accommodating unit 121 with respect to the spiral axis of the spiral coil 122.

Because the magnetic flux density is high in the spiral axis of the spiral coil 122, a portion of the aerosol generating article 200 adjacent to the spiral axis of the spiral coil 122 may be heated to a relatively higher temperature than the other portions.

Accordingly, when the plurality of spiral coils 122 arranged, because the center around which the spiral coil 122 is wound is arranged in a plurality of points of the outer wall of the accommodating unit 121, the aerosol generating article 200 accommodated in the accommodating unit 121 may be heated evenly.

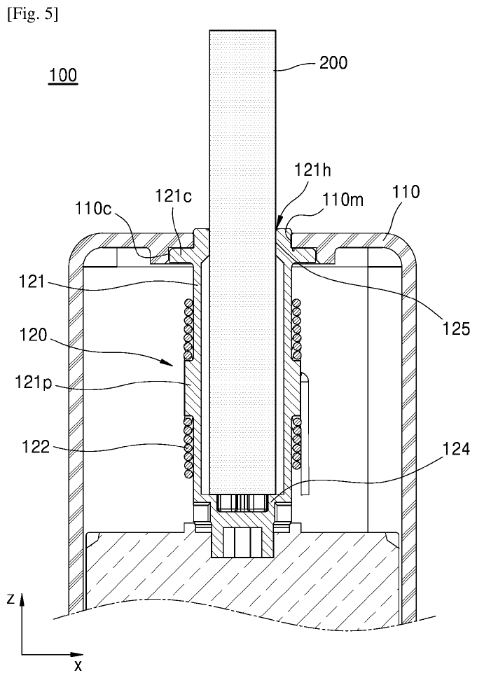

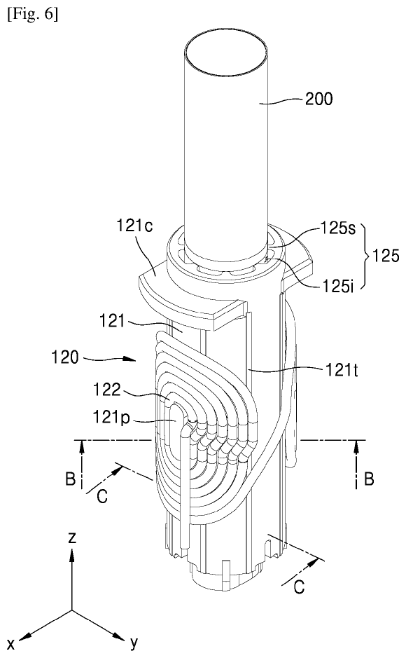

Hereinafter, the heating assembly 120 will be described in detail with reference to FIGS. 5 and 6.

FIGS. 5 and 6 are views for explaining the heating assembly according to an embodiment.

FIG. 5 is a cross-sectional view of the aerosol generating device illustrated in FIG. 1, taken along a line A-A. FIG. 6 is a perspective view of a heating assembly into which the aerosol generating article shown in FIG. 5 is inserted.

Referring to FIGS. 5 and 6, the aerosol generating device 100 according to an embodiment may include the housing 110 and the heating assembly 120. The heating assembly 120 may include the accommodating unit 121, the spiral coil 122, an end support 124, and a second support 125.

The housing 110 may include a coupling groove 110c, and the accommodating unit 121 may include a coupling portion 121c accommodated in the coupling groove 110c. The accommodating unit 121 may be fixed with respect to the housing 110 in the housing 110 by a coupling structure of the coupling groove 110c and the coupling portion 121c.

A portion of the inner wall of the housing 110 may protrude to form the coupling groove 110c. A portion of the outer wall of the accommodating unit 121 may protrude to form the coupling portion 121c.

Referring to FIG. 5, a portion of the inner wall of the housing 110 may protrude in the −z direction to form the coupling groove 110c. A portion of the outer wall of the accommodating unit 121 may protrude in the x-axis direction to form the coupling portion 121c. The structure and shape of the coupling groove 110c and the coupling portion 121c may be variously modified.

The accommodating unit 121 is mounted on the mounting hole 110m of the housing 110. The accommodating unit 121 may be supported by the mounting hole 110m and fixed with respect to the housing 110.

The accommodating unit 121 may include the opening 121h into which the aerosol generating article may be inserted. At least a portion of the aerosol generating article 200 may be inserted or accommodated in the accommodating unit 121 through the opening 121h.

The accommodating unit 121 may be disposed between the aerosol generating article 200 accommodated in the accommodating unit 121 and the spiral coil 122, thereby preventing heat generated from the aerosol generating article 200 from moving to the outside.

The accommodating unit 121 may include an insulating material that blocks heat generated in the aerosol generating article 200 from being emitted to outside the accommodating unit 121. For example, the accommodating unit 121 may include an insulating material with excellent insulation performance, such as ceramic and glass fibers. The insulating material of the accommodating unit 121 may be variously modified.

The accommodating unit 121 may have a cylindrical shape surrounding at least a portion of the outer wall of the accommodating unit 121. For example, the accommodating unit 121 may have a cylindrical shape, which is the same shape as the outer shape of the aerosol generating article 200.

The accommodating unit 121 may improve the heating efficiency of the heating assembly 120 by allowing the heat generated by the susceptor of the aerosol generating article 200 to be concentrated in the aerosol generating article 200. In addition, the accommodating unit 121 may shorten the preheating time of the aerosol generating device 100 and reduce power consumption.

The accommodating unit 121 may include a protruding portion 121p protruding to the outside. The protruding portion 121p may be inserted into the insertion hole (e.g., the insertion hole 122h of FIG. 3) of the spiral coil 122 arranged outside the accommodating unit 121. Therefore, the spiral coil 122 may be supported by the accommodating unit 121 to not be moved.

The shape of the protruding portion 121p may correspond to the shape of the insertion hole 122h. The number of the protruding portions 121p may be the same as the number of the spiral coil 122.

The spiral coil 122 may be arranged outside the accommodating unit 121 to generate an induced magnetic field toward the accommodating unit 121. Through induction heating of the susceptor included in the aerosol generating article 200 accommodated in the accommodating unit 121 by an induced magnetic field, the aerosol generating article 200 may be heated.

While the spiral coil 122 applies an induced magnetic field to the accommodating unit 121, heat may be generated in the spiral coil 122 itself. In this case, when the accommodating unit 121 becomes in contact with the spiral coil 122, the heat generated by the spiral coil 122 may be directly transferred to the accommodating unit 121. To reduce the heat transfer between the spiral coil 122 and the accommodating unit 121, the accommodating unit 121 and the spiral coil 122 need to be apart from each other.

To separate the spiral coil 122 from the outer wall of the accommodating unit 121, the accommodating unit 121 may include a contact portion 121t in the at least one area of the outer wall. The contact portion 121t may protrude towards the outside in the radial direction of the accommodating unit 121.

A plurality of contact portions 121t may be arranged along the circumferential direction of the accommodating unit. In addition, the plurality of contact portions 121t may be arranged to be apart from each other in the circumferential direction of the accommodating unit 121. In addition, each of the contact portion 121t may be extended in the length direction of the accommodating unit 121. Embodiments are not limited to the shape of the contact portion 121t shown in FIG. 6. For example, the contact portion 121t may have a protruding shape with a circular or oval cross section.

The contact portion 121t is in contact with the inner surface of the spiral coil 122 facing the accommodating unit 121. The contact portion 121t may support the spiral coil 122 such that the spiral coil 122 does not move in the radial direction of the accommodating unit. A region that is not in contact with the contact portion 121t in the inner surface of the spiral coil 122 may be apart from the outer wall of the accommodating unit 121.

The first supporter (not shown), the end supporter 124, and the second supporter 125 may be arranged inside the accommodating unit 121 to support at least one area of the aerosol generating article 200, and the aerosol generating article 200 accommodated in the accommodating unit 121 may be separated from the accommodating unit 121.

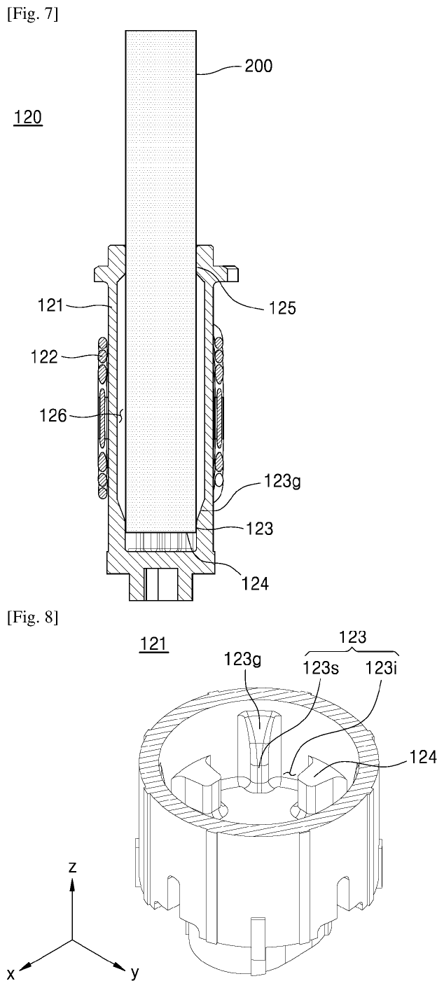

Hereinafter, the first supporter, the end supporter 124, and the second supporter 125 are described in detail with reference to FIGS. 7 to 10.

FIGS. 7 to 10 are views for explaining the supporter of the heating assembly according to an embodiment.

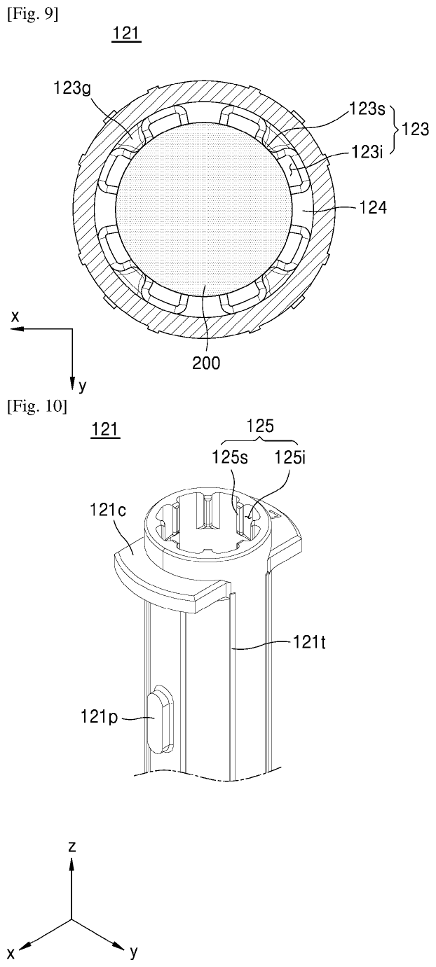

FIG. 7 is a cross-sectional view of the heating assembly illustrated in FIG. 6, taken along a line B-B. FIG. 8 is a perspective view of a portion of the accommodating unit, the view being a cross-section in a direction crossing the length direction of the accommodating unit of FIG. 6. FIG. 9 is a plan view of an aerosol generating article accommodated in a portion of the accommodating unit shown in FIG. 8. FIG. 10 is a perspective view of the other portion of the accommodating unit shown in FIG. 6.

In this case, the “cross section taken along a line B-B” refers to cross section of the x-z plane cut with a plane rotated by 45 degrees in a counterclockwise direction with respect to the z axis.

Referring to FIG. 7, the heating assembly 120 according to an embodiment may include the accommodating unit 121, the spiral coil 122, the first supporter 123, the end supporter 124, the second supporter 125, and an airflow passage 126.

The first supporter 123 may be arranged on one side of the inside of the accommodating unit 121 to support the outer surface of the aerosol generating article 200, and may separate the outer surface of the aerosol generating article 200 accommodated in the accommodating unit 121 from the inner wall of the accommodating unit 121.

In this case, the “one side” of the inside of the accommodating unit 121 is a portion of the accommodating unit 121 corresponding to an end of the aerosol generating article 200 accommodated in the accommodating unit 121. The “other side” of the inside of the accommodating unit 121 is another portion of the accommodating unit 121 in which the opening (e.g., the opening 121h of FIG. 5) open toward the outside is arranged.

In this case, “the outer surface of the aerosol generating article 200” refers to a surface facing the radial direction.

Referring to FIG. 8, the first supporter 123 may include a first support body 123s supporting the outer surface of the aerosol generating article 200, and a first inflow passage 123i for delivering air inside the accommodating unit 121 to an end of the aerosol generating article 200 accommodated in the accommodating unit 121.

When the outer surface of the aerosol generating article 200 accommodated in the accommodating unit 121 becomes in contact with the first support body 123s, the outer surface of the aerosol generating article 200 may be supported by the first support body 123s to not be moved in the radial direction of the accommodating unit 121.

A plurality of first support bodies 123s may be provided to stably support the aerosol generating article 200. Four first support bodies 123s are shown in FIG. 8, but embodiments are not limited to the number of first support bodies 123s.

The plurality of first support bodies 123s may be arranged to be apart from one other with equal spacing or irregular spacings along the inner wall of the accommodating unit 121 in the circumferential direction of the accommodating unit 121.

The first support body 123s may include a protruding shape towards the center of the accommodating unit 121 from the inner wall of the accommodating unit 121. As the aerosol generating article 200 is supported by the first support body 123s, the outer surface of the aerosol generating article 200 accommodated in the accommodating unit 121 may be apart from the inner wall of the accommodating unit 121 between the first support bodies 123s.

The space may form an air passage together with the first inflow passage 123i.

The internal air of the accommodating unit 121 may be introduced into the first inflow passage 123i of the first supporter 123. The air moving along the first inflow passage 123i may reach an end of the aerosol generating article 200.

The first supporter 123 may further include a guide unit 123g that protrudes toward the center of the accommodating unit 121 as it enters a side of the accommodating unit 121 to guide an operation in which the aerosol generating article 200 is inserted into the accommodating unit 121.

In the process of accommodating the aerosol generating article 200 in the accommodating unit 121, the end of the aerosol generating article 200 may be changed by an inclined surface of the guide unit 123g protruding toward the center of the accommodating unit 121 while being in contact with the guide unit 123g. The inclined surface of the guide unit 123g may change the end of the aerosol generating article 200 while smoothly guiding the movement of the aerosol generating article 200.

The guide unit 123g may be formed on the upper portion of the first support body 123s, and the guide unit 123g and the first support body 123s may be formed integrally. In this case, the “upper portion” refers to a portion located in the +z direction.

The aerosol generating article 200 moved along the inclined surface of the guide unit 123g is inserted into the first support body 123s. The outer surface of an end of the aerosol generating article 200 completely inserted in the accommodating unit 121 may be stably supported by the first support body 123s of the accommodating unit 121.

The end supporter 124 may be arranged on one side of the inside of the accommodating unit 121 to support an end surface of an end of the aerosol generating article 200, and may separate the end surface of an end of the aerosol generating article 200 accommodated in the accommodating unit 121 from a floor wall of the accommodating unit 121.

In this case, the “floor wall of the accommodating unit 121” is a wall facing the +% direction inside the accommodating unit 121, and may refer to an inner wall of the accommodating unit 121 facing the aerosol generating article 200 accommodated in the accommodating unit 121 in the length direction of the accommodating unit 121.

When the end surface of an end of the aerosol generating article 200 accommodated in the accommodating unit 121 becomes in contact with the end supporter 124, the end of the aerosol generating article 200 may be supported by the end supporter 124 to not be moved in the length direction of the accommodating unit 121.

The end supporter 124 may include a protruding shape toward the center of the accommodating unit 121 from the inner wall of the accommodating unit 121 such that the aerosol generating article 200 does not become in contact with the floor wall of one side of the accommodating unit 121 and is supported by the end supporter 124.

In FIG. 8, the end supporter 124 protrudes more than the first support body 123s protrudes to the center of the accommodating unit 121 from the inner wall of the accommodating unit 121, but embodiments are not limited to the degree of protrusion of an end supporter.

A plurality of end supporters 124 may be provided to stably support the aerosol generating article 200. Four end supporters 124 are shown in FIG. 9, but embodiments are not limited to the number of end supporters 124.

The plurality of end supporters 124 may be arranged to be apart from one other with equal spacing along the inner wall of the accommodating unit 121 in the circumferential direction of the accommodating unit 121.

The end supporter 124 may be arranged in an area of the first inflow passage 123i. For example, the end supporter 124 may be apart from each of the first support bodies 123s with equal spacing between two first support bodies 123s.

Since an end of the aerosol generating article 200 is separated from the floor wall of the accommodating unit 121 by the end supporter 124, air moved along the first inflow passage 123i may be delivered to an end of the aerosol generating article 200 and introduced inside the aerosol generating article 200.

The end supporter 124 shown in FIGS. 8 and 9 may support the aerosol generating article 200 only in the length direction of the accommodating unit 121. The shape of the end supporter 124 may be variously modified.

For example, the upper portion of the end supporter 124 may protrude as much as the first support body 123s protrudes toward the center of the accommodating unit 121 from the inner wall of the accommodating unit 121. Accordingly, the outer surface and the end surface of the aerosol generating article 200 may be in contact with the end supporter. The aerosol generating article 200 may be supported by the end supporter 124 to not be moved in the radial direction and the length direction of the accommodating unit 121.

The second supporter 125 may be arranged on the other side of the inside of the accommodating unit 121 to support the outer surface of the aerosol generating article 200, and may separate the outer surface of the aerosol generating article 200 accommodated in the accommodating unit 121 from the inner wall of the accommodating unit 121.

The second supporter 125 may include a second support body 125s for supporting the outer surface of the aerosol generating article 200 and a second inflow passage 125i for delivering air outside the accommodating unit 121 to the inside of the accommodating unit 121.

When the outer surface of the aerosol generating article 200 accommodated in the accommodating unit 121 becomes in contact with the second support body 125s, the outer surface of the aerosol generating article 200 may be supported by the second support body 125s to not be moved in the radial direction of the accommodating unit 121.

The first supporter 123 is arranged on one side of the inside of the accommodating unit 121, and the second supporter 125 is arranged on the other side of the inside of the accommodating unit 121, and thus, the aerosol generating article 200 accommodated in the accommodating unit 121 may be stably supported by the first supporter 123s and the second supporter 125s, which are apart from each other in the length direction of the accommodating unit 121.

In addition, a plurality of first support bodies 123s may be provided to stably support the aerosol generating article 200. Eight second support bodies 125s are shown in FIG. 10, but embodiments are not limited to the number of the second support bodies 125s.

The plurality of second support bodies 125s may be arranged to be apart from one other with equal spacing along the inner wall of the accommodating unit 121 in the circumferential direction of the accommodating unit 121.

The second support body 125s may include a protruding shape towards the center of the accommodating unit 121 from the inner wall of the accommodating unit 121. As the aerosol generating article 200 is supported by the second support body 125s, the outer surface of the aerosol generating article 200 accommodated in the accommodating unit 121 may be apart from the inner wall of the accommodating unit 121 between the second support bodies 125s.

The space may form an air passage together with the second inflow passage 125i.

The external air of the accommodating unit 121 may be introduced into the second inflow passage 125i of the second supporter 125. The air moving along the second inflow passage 125i may reach the inside of the accommodating unit 121.

The outer surface of the aerosol generating article 200 accommodated in the accommodating unit 121 may be apart from the inner wall of the accommodating unit 121 by the first supporter 123 and the second supporter 125. The space formed by the outer surface of the accommodated aerosol generating article 200 and the inner wall of the accommodating unit 121 which are apart from each other may form an airflow passage for the air inside the accommodating unit 121 to move along the outer surface of the aerosol generating article 200 to reach an end of the aerosol generating article 200.

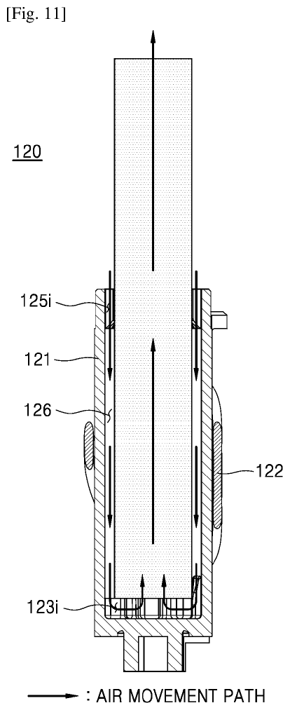

Hereinafter, the airflow passage 126 will be described in detail with reference to FIG. 11.

FIG. 11 is a cross-sectional view of the heating assembly illustrated in FIG. 6, taken along a C-C direction.

In this case, the “cross section taken along the C-C direction” refers to a cross section including the airflow passage. The “arrow shown in FIG. 11” refers to the flow of air.

Referring to FIG. 11, the airflow passage 126 may be connected to the first inflow passage 123i arranged at one side of the accommodating unit 121 and the second inflow passage 125i arranged at the other side of the accommodating unit 121.

When the user contacts the aerosol generating article 200 with the mouth and performs a puff operation, a pressure difference between the outer and the inner spaces of the aerosol generating device (not shown) may be generated, thereby causing external air to be introduced into the second inflow passage 125i of the second supporter 125.

The air that passed through the second inflow passage 125i may reach the airflow passage 126 between the inner wall of the accommodating unit 121 and the outer surface of the aerosol generating article 200. The air moving along the airflow passage 121 may be introduced into the first inflow passage 123i of the first supporter 123.

The air introduced into the first inflow passage 123i may reach an end of the aerosol generating article 200 accommodated in the accommodating unit 121. Since an end of the aerosol generating article 200 is arranged apart from the floor wall of the accommodating unit 121 by the end supporter 124, the air may pass through the first inflow passage 123i and be introduced into the aerosol generating article 200, the movement of the air forming a U-shape.

The air introduced into the aerosol generating article 200 may be mixed with vaporized particles generated as the aerosol generating article 200 is heated to generate an aerosol. The user may inhale the aerosol generated in the accommodating unit 121 through a puff operation of puffing the aerosol generating article 200.

As a result, the external air of the heating assembly 120 may move along the second inflow passage 125i, the airflow passage 126, and the first inflow passage 123i toward an end of the aerosol generating article 200. That is, the external air of the heating assembly 120 may move along the outer surface of the aerosol generating article 200 in the length direction of the accommodating unit 121.

A plurality of first support bodies (not shown) arranged in a side of the accommodating unit 121, a plurality of second support bodies (not shown) arranged on the other side of the accommodating unit 121, and a plurality of end supporters (not shown) may be aligned in a position corresponding to each other based on the circumferential direction of the accommodating unit 121 to face each other in the length direction of the accommodating unit 121.

According to the above-described arrangement structure of the first support body (not shown), the second support body (not shown), and the end supporter (not shown), the first inflow passage 123i and the second inflow passage 125i may be connected to each other in the length direction of the accommodating unit 121. Accordingly, the air may flow towards the −z direction in the accommodating unit 121.

In this case, “being connected in the length direction” may refer to the first inflow passage 123i and the second inflow passage 125i being connectively aligned along the length direction of the accommodating unit 121.

The air may be smoothly moved inside the heating assembly 120 through the second inflow passage 125i, the airflow passage 126, and the first inflow passage 123i.

When a distance between the outer surface of the aerosol generating article 200 accommodated in the accommodating unit 121 and the inner wall of the accommodating unit 121 is increased, a distance between the spiral coil 122 arranged outside the accommodating unit 121 and the susceptor of the aerosol generating article 200 may be increased, and thus, the heating efficiency of the aerosol generating article 200 may be reduced.

When a distance between the outer surface of the aerosol generating article 200 accommodated in the accommodating unit 121 and the inner wall of the accommodating unit 121 is decreased, the accommodating unit 121 may be heated through heat generated in the susceptor of the aerosol generating article 200, and thus, an efficiency of blocking heat from being emitted to the outside of the accommodating unit 121 (hereinafter referred to as the “insulation efficiency of the accommodating unit 121”) may be reduced.

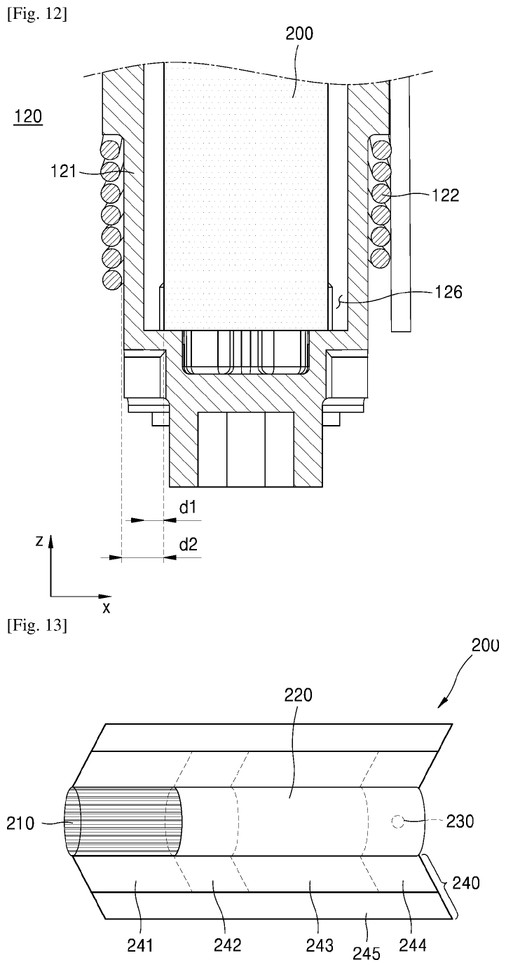

That is, an appropriate distance between the components constituting the heating assembly 120 is important. Therefore, the distance between the components of the heating assembly 120 will be described with reference to FIG. 12 below.

FIG. 12 is a cross-sectional view of a portion of the heating assembly shown in FIG. 5.

Referring to FIG. 12, the heating assembly 120 according to an embodiment may include the accommodating unit 121, the spiral coil 122, and the airflow passage 126.

The distance between the susceptor of the aerosol generating article 200 and the accommodating unit 121 may affect the insulation efficiency of the accommodating unit 121.

In addition, the distance between the susceptor of the aerosol generating article 200 and the spiral coil 122 may affect the heating efficiency of the aerosol generating article 200.

A distance d1 from the outer surface of the aerosol generating article 200 to the inner wall of the accommodating unit 121 in the radial direction of the accommodating unit 121 may be at least 0.2 mm and 3 mm at most, considering the insulation efficiency of the accommodating unit 121 and the smooth movement of the heat and air in the accommodating unit 121.

Because a distance d2 from the outer surface of the aerosol generating article 200 to the inner surface of the spiral coil 122 facing the accommodating unit 121 in the radial direction of the accommodating unit 121 includes the distance d1 from the outer surface of the aerosol generating article 200 to the inner wall of the accommodating unit 121, the distance d2 may be 3 mm at most, considering the heating efficiency of the aerosol generating article 200, the thickness of the accommodating unit 121 itself, the distance between the outer wall of the accommodating unit 121 and the spiral coil 122, etc., in addition to the above-described elements to consider.

FIG. 13 illustrates an example of the aerosol generating article.

Referring to FIG. 13, the aerosol generating article 200 includes a tobacco rod 210 and a filter rod 220. FIG. 13 illustrates that the filter rod 220 includes a single segment, but is limited thereto. In other words, the filter rod 220 may include a plurality of segments.

For example, the filter rod 220 may include a first segment configured to cool an aerosol and a second segment configured to filter a certain component included in the aerosol. Also, as necessary, the filter rod 220 may further include at least one segment configured to perform other functions.

The aerosol generating article 200 may be packaged by at least one wrapper 240. The wrapper 240 may have at least one hole through which external air may be introduced or internal air may be discharged. For example, the aerosol generating article 200 may be packaged by one wrapper 240. As another example, the aerosol generating article 200 may be doubly packaged by two or more wrappers 240. For example, the tobacco rod 210 may be packaged by a first wrapper 241, and the filter rod 220 may be packaged by wrappers 242, 243, 244. Also, the entire aerosol generating article 200 may be re-packaged by another single wrapper 245. When the filter rod 220 includes a plurality of segments, each segment may be packaged by wrappers 242, 243, 244.

The tobacco rod 210 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but is not limited thereto. Also, the tobacco rod 210 may include other additives, such as flavors, a wetting agent, and/or organic acid. Also, the tobacco rod 210 may include a flavored liquid, such as menthol or a moisturizer, which is sprayed onto the tobacco rod 210.

The tobacco rod 210 may be manufactured in various forms. For example, the tobacco rod 210 may be formed as a sheet or a strand.

Also, the tobacco rod 210 may be formed as a pipe tobacco, which is formed of tiny bits cut from a tobacco sheet.

The tobacco rod 210 may include a susceptor that generates heat by the magnetic field. The susceptor may include metal or carbon. The susceptor may include at least one of ferrite, ferromagnetic alloy, stainless steel, and Al. In addition, the susceptor may include at least one of a ceramic such as graphite, molybdenum, silicon carbide, niobium, nickel alloy, metal film, or zirconia, a transition metal such as nickel (Ni) or cobalt (Co), and a metalloid such as boron (B) or phosphorus (P).

The susceptor included in the tobacco rod 210 may be manufactured in various forms. For example, the susceptor may be formed as a sheet and surround the outside of tobacco rod 210. As another example, the susceptor may be formed as a strand or particle, and a plurality of susceptors may be dispersed in the tobacco rod 210.

Also, the tobacco rod 210 may be surrounded by a heat conductive material. For example, the heat conductive material may be, but not limited to, a metal foil such as aluminum foil. For example, the heat conductive material surrounding the tobacco rod 210 may uniformly distribute heat transmitted to the tobacco rod 210, and thus, the heat conductivity applied to the tobacco rod 210 may be increased, and the taste of the aerosol generated from the tobacco rod 210 may be improved accordingly. Also, the heat conductive material surrounding the tobacco rod 210 may function as a susceptor heated by the magnetic field.

The filter rod 220 may include a cellulose acetate filter. Shapes of the filter rod 220 are not limited. For example, the filter rod 220 may include a cylinder-type rod or a tube-type rod having a hollow inside. Also, the filter rod 220 may include a recess-type rod. When the filter rod 220 includes a plurality of segments, at least one of the plurality of segments may have a different shape.

The filter rod 220 may be formed to generate flavors. For example, a flavoring liquid may be sprayed onto the filter rod 220, or an additional fiber coated with a flavoring liquid may be inserted into the filter rod 220.

Also, the filter rod 220 may include at least one capsule 230. Here, the capsule 230 may generate a flavor or an aerosol. For example, the capsule 230 may have a configuration in which a liquid containing a flavoring material is wrapped with a film. For example, the capsule 230 may have a spherical or cylindrical shape, but is not limited thereto.

When the filter rod 220 includes a segment configured to cool the aerosol, the cooling segment may include a polymer material or a biodegradable polymer material. For example, the cooling segment may include pure polylactic acid alone, but the material for forming the cooling segment is not limited thereto. In some embodiments, the cooling segment may include a cellulose acetate filter having a plurality of holes. However, the cooling segment is not limited to the above-described example and is not limited as long as the cooling segment cools the aerosol.

Although not illustrated in the drawings, the aerosol generating article 200 may further include a front-end plug. The front-end plug may be located on a side of the tobacco rod 210 opposite to the filter rod 220. The front-end plug may prevent the tobacco rod 210 from being detached outwards and prevent a liquefied aerosol from flowing into the aerosol generating device 100 (FIG. 1) from the tobacco rod 210, during smoking.

### Experimental Example Comparing Heating Performances of the Aerosol Generating Devices

The experiment was conducted to compare the heating performance of the aerosol generating device according to an embodiment and the conventional aerosol generating device.

In the experiment, an aerosol generating article including a sheet-type susceptor was used, and an aluminum foil was used as the sheet-type susceptor. The aluminum foil was placed to surround the cigarette rod of the aerosol generating article.

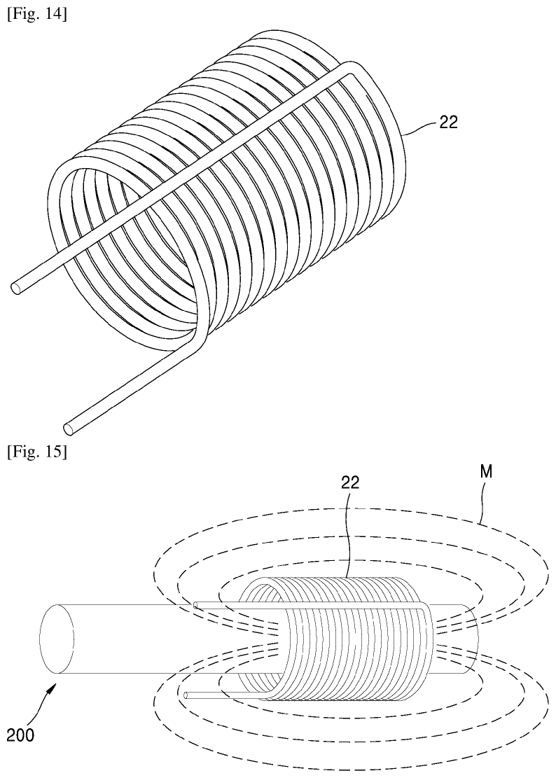

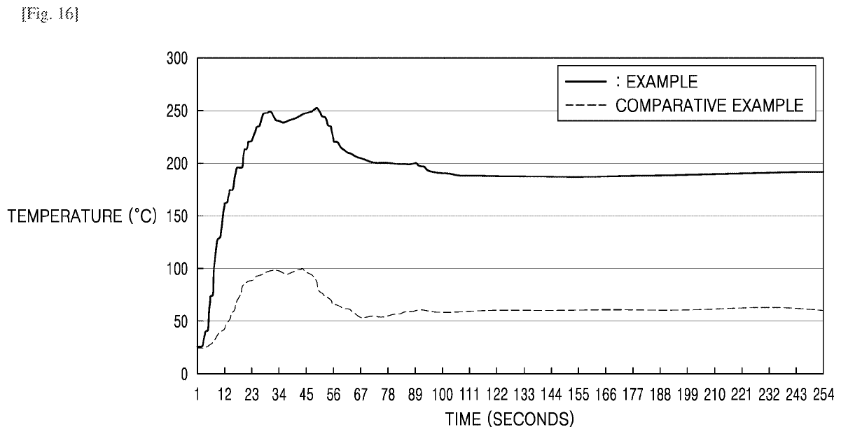

FIGS. 14 and 15 are each a view for explaining a coil of an induction-heating type aerosol generating device, which is used as a comparative example.

FIG. 14 is a view schematically illustrating the coil of the conventional aerosol generating device, and FIG. 15 is a view illustrating a direction of a magnetic force line generated by the coil of the conventional induction-heating type aerosol generating device.

Referring to FIGS. 14 and 15, the coil 22 included in the conventional induction-heating type aerosol generating device is generally implemented as a solenoid which is made thoroughly and evenly winding a conductive line in a long cylindrical shape. An accommodating space in which the aerosol generating article 200 is inserted may be included in the inner space of the solenoid.

The coil 22 included in the conventional induction-heating type aerosol generating device may form a magnetic field in which the magnetic force line M enters and exits the inside of the solenoid according to the direction of the current. That is, the magnetic force line M may enter and exit in the length direction of the accommodating space, and the magnetic force line M may pass the inside of the aerosol generating article 200 in the same direction as the length direction of the aerosol generating article 200. Here the length direction of the accommodating space refers to a direction in which the length of the accommodating space extends or a direction in which the aerosol generating article 200 is inserted to the accommodating space. In addition, the “length direction of the aerosol generating article 200” means a direction in which a length of the aerosol generating article 200 extends or a direction in which the aerosol generating article 200 is inserted into an aerosol generating device.

Because the direction of the magnetic force line M is the same as the length direction of the aerosol generating article 200, the density of the magnetic force line M passing through the susceptor included in the aerosol generating article 200 may decrease, and accordingly, the susceptor may not emit sufficient heat energy. In particular, if the susceptor included in the aerosol generating article 200 is in the form of a sheet surrounding the aerosol generating article 200, the magnetic force line M may hardly pass through the large area of the sheet. Accordingly, because the susceptor is not sufficiently heated, the aerosol generating article 200 may not be efficiently heated.

The aerosol generating article was heated by using an aerosol generating device (hereinafter referred to as a comparative example) including a solenoid as shown in FIG. 14 and an aerosol generating device including the spiral coil 122 as shown in FIG. 2 (hereinafter referred to as an example), and the temperature change of the aluminum foil of the aerosol generating article was measured over time. Alternating currents of the same condition were applied to the solenoid of the comparative example and the spiral coil of the example.

FIG. 16 is a graph showing a result of an experiment conducted to compare the heating performance of the aerosol generating device according to an example and the conventional aerosol generating device.

FIG. 16 shows a graph of temperature changes over time in an aluminum foil of an aerosol generating article heated by the experiments of the example and the comparative example.

Referring to FIG. 16, the aluminum foil of the aerosol generating article of the example was heated to a temperature range of about 200° C. to about 250° C. except for the preheating section, while the aluminum foil of the aerosol generating article of the comparative example was heated to a temperature range of about 50° C. to about 100° C. Considering that the aerosol generating material (glycerin, etc.) included in the aerosol generating article has a vaporization temperature of about 140° C. to about 250° C., it was confirmed that generating a normal aerosol in the comparative example is difficult.

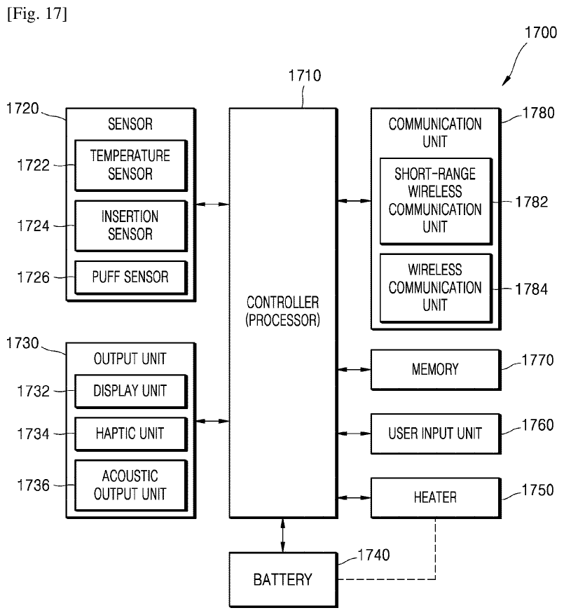

FIG. 17 is a block diagram of an aerosol generating device 1700 according to another embodiment.

The aerosol generating device 1700 may include a controller 1710, a sensing unit 1720, an output unit 1730, a battery 1740, a heater 1750, a user input unit 1760, a memory 1770, and a communication unit 1780. However, the internal structure of the aerosol generating device 1700 is not limited to those illustrated in FIG. 17. That is, according to the design of the aerosol generating device 1700, it will be understood by one of ordinary skill in the art that some of the components shown in FIG. 17 may be omitted or new components may be added.

The sensing unit 1720 may sense a state of the aerosol generating device 1700 and a state around the aerosol generating device 1700, and transmit sensed information to the controller 1710. Based on the sensed information, the controller 1710 may control the aerosol generating device 1700 to perform various functions, such as controlling an operation of the heater 1750, limiting smoking, determining whether an aerosol generating article (e.g., a cigarette, a cartridge, or the like) is inserted, displaying a notification, or the like.

The sensing unit 1720 may include at least one of a temperature sensor 1722, an insertion detection sensor 1724, and a puff sensor 1726, but is not limited thereto.

The temperature sensor 1722 may sense a temperature at which the heater 1750 (or an aerosol generating material) is heated. The aerosol generating device 1700 may include a separate temperature sensor for sensing the temperature of the heater 1750, or the heater 1750 may serve as a temperature sensor. Alternatively, the temperature sensor 1722 may also be arranged around the battery 1740 to monitor the temperature of the battery 1740.

The insertion detection sensor 1724 may sense insertion and/or removal of an aerosol generating article. For example, the insertion detection sensor 1724 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 1726 may sense a user's puff on the basis of various physical changes in an airflow passage or an airflow channel. For example, the puff sensor 1726 may sense a user's puff on the basis of any one of a temperature change, a flow change, a voltage change, and a pressure change.

The sensing unit 1720 may include, in addition to the temperature sensor 1722, the insertion detection sensor 1724, and the puff sensor 1726 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1730 may output information on a state of the aerosol generating device 1700 and provide the information to a user. The output unit 1730 may include at least one of a display unit 1732, a haptic unit 1734, and a sound output unit 1736, but is not limited thereto. When the display unit 1732 and a touch pad form a layered structure to form a touch screen, the display unit 1732 may also be used as an input device in addition to an output device.

The display unit 1732 may visually provide information about the aerosol generating device 1700 to the user. For example, information about the aerosol generating device 1700 may mean various pieces of information, such as a charging/discharging state of the battery 1740 of the aerosol generating device 1700, a preheating state of the heater 1750, an insertion/removal state of an aerosol generating article, or a state in which the use of the aerosol generating device 1700 is restricted (e.g., sensing of an abnormal object), or the like, and the display unit 1732 may output the information to the outside. The display unit 1732 may be, for example, a liquid crystal display panel (LCD), an organic light-emitting diode (OLED) display panel, or the like. In addition, the display unit 1732 may be in the form of a light-emitting diode (LED) light-emitting device.

The haptic unit 1734 may tactilely provide information about the aerosol generating device 1700 to the user by converting an electrical signal into a mechanical stimulus or an electrical stimulus. For example, the haptic unit 1734 may include a motor, a piezoelectric element, or an electrical stimulation device.

The sound output unit 1736 may audibly provide information about the aerosol generating device 1700 to the user. For example, the sound output unit 1736 may convert an electrical signal into a sound signal and output the same to the outside.

The battery 1740 may supply power used to operate the aerosol generating device 1700. The battery 1740 may supply power such that the heater 1750 may be heated. In addition, the battery 1740 may supply power required for operations of other components (e.g., the sensing unit 1720, the output unit 1730, the user input unit 1760, the memory 1770, and the communication unit 1780) in the aerosol generating device 1700. The battery 1740 may be a rechargeable battery or a disposable battery. For example, the battery 1740 may be a lithium polymer (LiPoly) battery, but is not limited thereto.

The heater 1750 may receive power from the battery 1740 to heat an aerosol generating material. Although not illustrated in FIG. 17, the aerosol generating device 1700 may further include a power conversion circuit (e.g., a direct current (DC)/DC converter) that converts power of the battery 1740 and supplies the same to the heater 1750. In addition, when the aerosol generating device 1700 generates aerosols in an induction heating method, the aerosol generating device 1700 may further include a DC/alternating current (AC) that converts DC power of the battery 1740 into AC power.

The controller 1710, the sensing unit 1720, the output unit 1730, the user input unit 1760, the memory 1770, and the communication unit 1780 may each receive power from the battery 1740 to perform a function. Although not illustrated in FIG. 17, the aerosol generating device 1700 may further include a power conversion circuit that converts power of the battery 1740 to supply the power to respective components, for example, a low dropout (LDO) circuit, or a voltage regulator circuit.

In an embodiment, the heater 1750 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1750 may be implemented by a metal wire, a metal plate on which an electrically conductive track is arranged, a ceramic heating element, or the like, but is not limited thereto.

In another embodiment, the heater 1750 may be a heater of an induction heating type. For example, the heater 1750 may include a susceptor that heats an aerosol generating material by generating heat through a magnetic field applied by a coil.

The user input unit 1760 may receive information input from the user or may output information to the user. For example, the user input unit 1760 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 17, the aerosol generating device 1700 may further include a connection interface, such as a universal serial bus (USB) interface, and may connect to other external devices through the connection interface, such as the USB interface, to transmit and receive information, or to charge the battery 1740.

The memory 1770 is a hardware component that stores various types of data processed in the aerosol generating device 1700, and may store data processed and data to be processed by the controller 1710. The memory 1770 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1770 may store an operation time of the aerosol generating device 1700, the maximum number of puffs, the current number of puffs, at least one temperature profile, data on a user's smoking pattern, etc.

The communication unit 1780 may include at least one component for communication with another electronic device. For example, the communication unit 1780 may include a short-range wireless communication unit 1782 and a wireless communication unit 1784.

The short-range wireless communication unit 1782 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 1784 may include a cellular network communication unit, an Internet communication unit, a computer network (e.g., local area network (LAN) or wide area network (WAN)) communication unit, or the like, but is not limited thereto. The wireless communication unit 1784 may also identify and authenticate the aerosol generating device 1700 within a communication network by using subscriber information (e.g., International Mobile Subscriber Identifier (IMSI)).

The controller 1710 may control general operations of the aerosol generating device 1700. In an embodiment, the controller 1710 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 1710 may control the temperature of the heater 1750 by controlling supply of power of the battery 1740 to the heater 1750. For example, the controller 1710 may control power supply by controlling switching of a switching element between the battery 1740 and the heater 1750. In another example, a direct heating circuit may also control power supply to the heater 1750 according to a control command of the controller 1710.

The controller 1710 may analyze a result sensed by the sensing unit 1720 and control subsequent processes to be performed. For example, the controller 1710 may control power supplied to the heater 1750 to start or end an operation of the heater 1750 on the basis of a result sensed by the sensing unit 1720. As another example, the controller 1710 may control, based on a result sensed by the sensing unit 1720, an amount of power supplied to the heater 1750 and the time the power is supplied, such that the heater 1750 may be heated to a certain temperature or maintained at an appropriate temperature.

The controller 1710 may control the output unit 1730 on the basis of a result sensed by the sensing unit 1720. For example, when the number of puffs counted through the puff sensor 1726 reaches a preset number, the controller 1710 may notify the user that the aerosol generating device 1700 will soon be terminated through at least one of the display unit 1732, the haptic unit 1734, and the sound output unit 1736.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. A heating assembly comprising:
an accommodating unit configured to accommodate an aerosol generating article heatable by an induced magnetic field;
a spiral coil arranged outside the accommodating unit and configured to generate an induced magnetic field toward the accommodating unit; and
a first supporter arranged at a side in the accommodating unit, supporting an outer surface of the aerosol generating article, and separating the outer surface of the aerosol generating article accommodated in the accommodating unit from an inner wall of the accommodating unit, wherein
the spiral coil is wound to form a plate shape covering a portion of an outer wall of the accommodating unit, and a center around which the spiral coil is wound is arranged at a point of the outer wall of the accommodating unit.

2. The heating assembly of claim 1, wherein
at least a portion of the outer wall of the accommodating unit comprises a curved wall, and
the spiral coil has a plate shape curved along the outer wall of the accommodating unit.

3. The heating assembly of claim 1, wherein the heating assembly comprises a plurality of spiral coils, and at least one pair of the plurality of spiral coils is electrically connected to each other.

4. The heating assembly of claim 3, wherein the spiral coils are provided in even numbers.

5. The heating assembly of claim 1, wherein the accommodating unit comprises an insulating material to block heat generated in the aerosol generating article from being emitted to outside the accommodating unit.

6. The heating assembly of claim 1, wherein
the spiral coil comprises an insertion hole at the center thereof, and
the accommodating unit comprises a protruding portion to be protruded outwards of the accommodating unit and be inserted into the insertion hole.

7. The heating assembly of claim 1, wherein the accommodating unit comprises a contact portion to separate the spiral coil from the inner wall of the accommodating unit.

8. The heating assembly of claim 1, wherein the first supporter comprises a first support body to support the outer surface of the aerosol generating article and a first inflow passage to deliver air in the accommodating unit to an end of the aerosol generating article accommodated in the accommodating unit.

9. The heating assembly of claim 1, wherein the first supporter comprises a guide unit protruding toward a center of the accommodating unit as the guide unit enters a side of the accommodating unit, the guide unit configured to guide an operation in which the aerosol generating article is inserted into the accommodating unit.

10. The heating assembly of claim 1, further comprising an end supporter arranged at a side in the accommodating unit, supporting one end of the aerosol generating article, and separating the one end of the aerosol generating article accommodated in the accommodating unit from a floor wall of the accommodating unit.

11. The heating assembly of claim 1, further comprising a second supporter arranged at another side in the accommodating unit, supporting an outer surface of the aerosol generating article, and separating the outer surface of the aerosol generating article accommodated in the accommodating unit from an inner wall of the accommodating unit, wherein
the second supporter comprises a second support body supporting the outer surface of the aerosol generating article and a second inflow passage configured to deliver air outside the accommodating unit to inside the accommodating unit.

12. The heating assembly of claim 1, wherein the inner wall of the accommodating unit is apart from the outer surface of the aerosol generating article accommodated in the accommodating unit to form an airflow passage in which air moves along the outer surface of the aerosol generating article to an end of the aerosol generating article.

13. The heating assembly of claim 1, wherein a distance between the outer surface of the aerosol generating article accommodated in the accommodating unit and an inner wall of the accommodating unit in a radial direction of the accommodating unit is about 0.2 mm to about 3 mm.

14. The heating assembly of claim 1, wherein a distance between the outer surface of the aerosol generating article accommodated in the accommodating unit and an inner surface of the spiral coil facing the accommodating unit in a radial direction of the accommodating unit is about 3 mm at most.

15. An aerosol generating device comprising:
the heating assembly according to claim 1;
a housing configured to accommodate the heating assembly; and
a battery configured to supply power to the heating assembly.
